(19) United States
(12) Patent Application Publication
(10) Pub. No.: US 2004/0124042 A1
(43) Pub. Date: Jul. 1, 2004

(54) Electric mechanical brake assembly having a worm or cluster gear set

(76) Inventor: Richard James Kriz II, Harlan, IN (US)

Correspondence Address: Scott A. Mcbain, Delphi Technologies, Inc., Legal Staff - Mail Code: 480-410-202, P.O Box 5052, Troy, MI, 48007, US

(21) Appl. No.: 10/335,311

(22) Filed: Dec. 31, 2002

(51) Int. Cl. B60L 7/00

(52) U.S. Cl. 188/162

(57) ABSTRACT

An electric mechanical brake assembly including an electric-mechanical-brake ballscrew subassembly, a first electric motor, and a first worm or cluster gear set. The electric-mechanical-brake ballscrew subassembly has a rotatable actuation member and has a linearly-movable member which is driven by the actuation member and which is attachable to a brake pad. The first electric motor has a first drive shaft. The first worm or cluster gear set at least in part operatively connects the first drive shaft to the actuation member.

### TECHNICAL FIELD

The present invention relates generally to brakes, and more particularly to an electric mechanical brake assembly.

### BACKGROUND OF THE INVENTION

Conventional electric mechanical brakes, also known as electric brake calipers, utilize an electric motor to drive an inline rotatable ballscrew of a ballscrew subassembly positioned within the caliper housing. The rotating ballscrew linearly moves a ballnut of the ballscrew subassembly. The ballnut is connected to, and linearly moves, an inner brake pad against a brake rotor of a vehicle. An outer brake pad, mounted to the caliper housing, is positioned on an opposite side of the brake rotor. Therefore, during braking, the inner brake pad will be forced against the rotor and a resulting reactionary force will pull the outer brake pad into engagement with the opposite side of the rotor. Engagement of the inner and outer brake pads with the rotor will slow and stop the vehicle or hold a stopped vehicle in a fixed position.

What is needed is an improved electric mechanical brake.

### SUMMARY OF THE INVENTION

A first expression of a first embodiment of the invention is for an electric mechanical brake assembly including an electric-mechanical-brake ballscrew subassembly, a first electric motor, and a first worm gear set. The electric-mechanical-brake ballscrew subassembly has a rotatable actuation member and has a linearly-movable member which is driven by the actuation member and which is attachable to a brake pad. The first electric motor has a first drive shaft. The first worm gear set at least in part operatively connects the first drive shaft to the actuation member.

A first expression of a second embodiment of the invention is for an electric mechanical brake assembly including an electric-mechanical-brake ballscrew subassembly, a first electric motor, and a first cluster gear set. The electric-mechanical-brake ballscrew subassembly has a rotatable actuation member and has a linearly-movable member which is driven by the actuation member and which is attachable to a brake pad. The first electric motor has a first drive shaft. The first cluster gear set at least in part operatively connects the first drive shaft to the actuation member.

A broader expression of the invention which includes the first expressions of both the first and second embodiments of the invention is for an electric mechanical brake assembly including an electric-mechanical-brake ballscrew subassembly, a first electric motor, and a first worm or cluster gear set. The electric-mechanical-brake ballscrew subassembly has a rotatable actuation member and has a linearly-movable member which is driven by the actuation member and which is attachable to a brake pad. The first electric motor has a first drive shaft. The first worm or cluster gear set at least in part operatively connects the first drive shaft to the actuation member.

Several benefits and advantages are derived from one or more of the embodiments of the invention. Having a worm or cluster gear set at least in part operatively connect the first drive shaft of the first electric motor to the actuation member of the electric-mechanical-brake ballscrew subassembly allows a greater gear reduction for similar size gear trains (or equal gear reduction in a smaller package size) than designs which use an idler gear and allows an equal gear reduction to designs which require a hollow (and more-costly-to-manufacture) shaft actuation member of the ballscrew subassembly to add required planetary reduction gears inside the hollow shaft actuation member. Typically, such embodiments of the invention have fewer parts and are more efficient by having fewer gear meshes.

### SUMMARY OF THE DRAWINGS

FIG. 1 is a schematic top planar view of a first embodiment of the invention showing an electric mechanical brake assembly including a first worm gear set;

FIG. 2 is a view of the electric mechanical brake assembly of FIG. 1 taken along lines 2-2 of FIG. 1;

FIG. 3 is a view, as in FIG. 2, but of an alternate configuration showing the first and second electric motors sharing a common first drive shaft;

FIG. 4 is a schematic top planar view of a second embodiment of the invention showing an electric mechanical brake assembly including a first cluster gear set;

FIG. 5 is a view, as in FIG. 4, but of an alternate configuration showing the first and second electric motors sharing a common first drive shaft; and

FIG. 6 is a view, as in FIG. 4, but of a substitute configuration showing the second electric motor and the second motor gear, wherein the second motor gear engages the first driven gear of the first cluster gear set.

### DESCRIPTION OF THE PREFERRED EMBODIMENTS

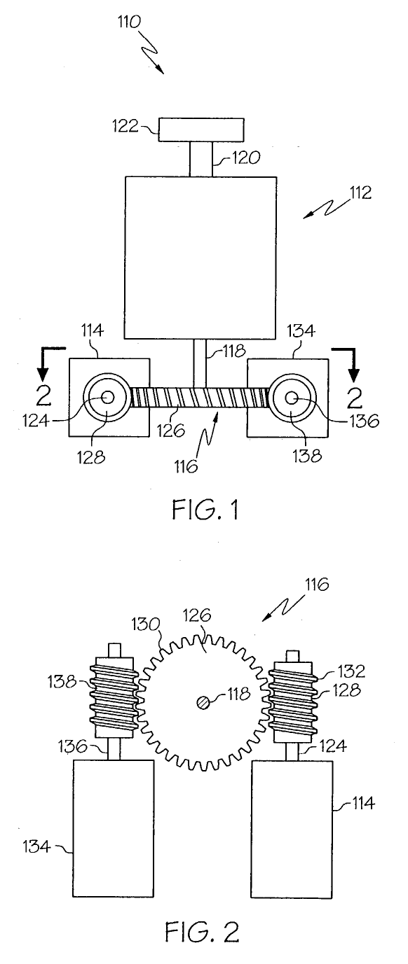

Referring now to the drawings, FIGS. 1-2 illustrate a first embodiment of the present invention. A first expression of the first embodiment shown in FIGS. 1-2 is for an electric mechanical brake assembly 110 including an electric-mechanical-brake ballscrew subassembly 112, a first electric motor 114, and a first worm gear set 116. The electric-mechanical-brake ballscrew subassembly 112 has a rotatable actuation member 118 and has a linearly-movable member 120 which is driven by the actuation member 118 and which is attachable to a brake pad 122. The first electric motor 114 has a first drive shaft 124. The first worm gear set 116 at least in part operatively connects the first drive shaft 124 to the actuation member 118.

In a first example of the first expression of the first embodiment, the first worm gear set 116 has a first worm gear 126 attached to the actuation member 118 and has a first worm (which is the gear which drives the worm gear) 128 attached to the first drive shaft 124 and engaging the first worm gear 126. In one modification, the first worm gear 126 has a first number of worm teeth 130, the first worm 128 has a worm thread 132, and one turn of the first worm 128 passes a number of worm teeth 130 less than the first number. In one variation, the first worm gear 126 has twenty-five worm teeth 130, and one turn of the first worm 128 passes one of the twenty-five worm teeth 130 yielding a gear reduction ratio of twenty-five to one for the first worm gear set 116. Other variations are left to the artisan. In one construction, the actuation member 118 of the ballscrew subassembly 112 is a solid shaft.

In the same or a different example, the ballscrew subassembly 112 is at least partially disposed within a housing (not shown). In one application, the brake pad 122 is a vehicle brake pad. In one implementation, the vehicle brake pad is an inner brake pad of an automotive vehicle. The operation of an electric-mechanical-brake ballscrew subassembly to move a brake pad in an electric-mechanical-brake-caliper housing of a motor vehicle is well known. In one design, the actuation member is the shaft of the ballscrew subassembly and the linearly-movable member is the nut of the ballscrew subassembly. In another design, the actuation member is the nut of the ballscrew subassembly and the linearly-movable member is the shaft of the ballscrew subassembly. Such designs are within the level of skill of the artisan. Other applications (including non-vehicle applications), other implementations, and other ballscrew subassembly designs are left to the artisan. It is noted that the terminology “ballscrew subassembly” includes all mechanical motion transfer devices which transfer rotation of a rotatable actuation member into linear movement of a linearly-movable member, as can be appreciated by those skilled in the art.

In one arrangement of the first expression of the first embodiment shown in FIGS. 1-2, the electric mechanical brake assembly 110 also includes a second electric motor 134 having a second drive shaft 136, and further includes a second worm 138 attached to the second drive shaft 136 and engaging the first worm gear 126. In one variation, the first and second worms 128 and 138 are diametrically opposed about the first worm gear 126.

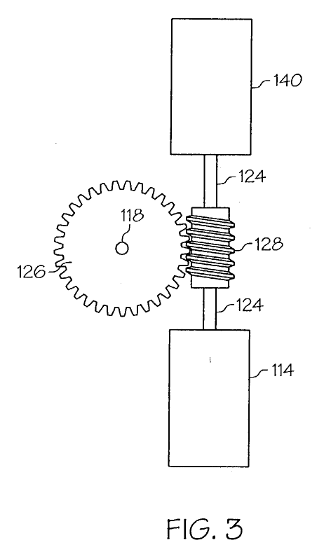

FIG. 3 shows an alternate configuration, wherein the electric mechanical brake assembly also includes a second electric motor 140 which shares the first drive shaft 124 of the first electric motor 114, wherein the first worm 128 attached to the first drive shaft 124 engages the first worm gear 126 attached to the actuation member 118. It is noted that two electric motors having separate drive shafts which are attached together are said to share a drive shaft.

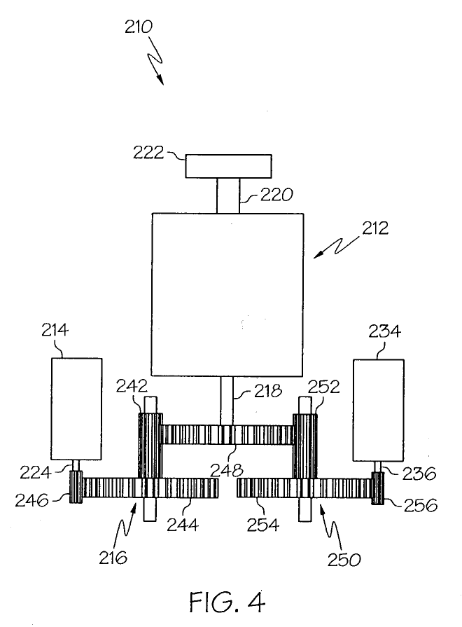

Referring again to the drawings, FIG. 4 illustrates a second embodiment of the present invention. A first expression of the second embodiment shown in FIG. 4 is for an electric mechanical brake assembly 210 including an electric-mechanical-brake ballscrew subassembly 212, a first electric motor 214, and a first cluster gear set 216. The electric-mechanical-brake ballscrew subassembly 212 has a rotatable actuation member 218 and has a linearly-movable member 220 which is driven by the actuation member 218 and which is attachable to a brake pad 222. The first electric motor 214 has a first drive shaft 224. The first cluster gear set 216 at least in part operatively connects the first drive shaft 224 to the actuation member 218. It is noted that a cluster gear set is also known as a compound gear set and allows double reduction gearing when implemented as shown.

In a first example of the first expression of the second embodiment, the first cluster gear set 216 has a first driving gear 242 and has a first driven gear 244 coaxially and nonrotatably attached to the first driving gear 242, wherein the first driven gear 244 engages a first motor gear 246 attached to the first drive shaft 224, and wherein the first driving gear 242 engages a ballscrew gear 248 attached to the actuation member 218. In one modification, the first driven gear 244 has more gear teeth than the first motor gear 246, and the ballscrew gear 248 has more gear teeth than the first driving gear 242. In one variation, the first driven gear 244 has fifty gear teeth and the first motor gear 246 has ten gear teeth for a gear reduction of five to one, and the ballscrew gear 248 has fifty gear teeth and the first driving gear 242 has ten gear teeth for a gear reduction of five to one, wherein the two gear reduction ratios are multiplied to yield an overall gear reduction of twenty-five to one for the first cluster gear set 216. In one construction, the actuation member 218 of the ballscrew subassembly 212 is a solid shaft.

In the same or a different example, the ballscrew subassembly 212 is at least partially disposed within a housing (not shown). In one application, the brake pad 222 is a vehicle brake pad. In one implementation, the vehicle brake pad is an inner brake pad of an automotive vehicle. The operation of an electric-mechanical-brake ballscrew subassembly to move a brake pad in an electric-mechanical-brake-caliper housing of a motor vehicle is well known. In one design, the actuation member is the shaft of the ballscrew subassembly and the linearly-movable member is the nut of the ballscrew subassembly. In another design, the actuation member is the nut of the ballscrew subassembly and the linearly-movable member is the shaft of the ballscrew subassembly. Such designs are within the level of skill of the artisan. Other applications (including non-vehicle applications), other implementations, and other ballscrew subassembly designs are left to the artisan. It is noted that the terminology “ballscrew subassembly” includes all mechanical motion transfer devices which transfer rotation of a rotatable actuation member into linear movement of a linearly-movable member, as can be appreciated by those skilled in the art.

In one arrangement of the first expression of the second embodiment shown in FIG. 4, the electric mechanical brake assembly 210 also includes a second electric motor 234 having a second drive shaft 236, and further including a second cluster gear set 250 having a second driving gear 252 and having a second driven gear 254 coaxially and nonrotatably attached to the second driving gear 252, wherein the second driven gear 254 engages a second motor gear 256 attached to the second drive shaft 236, and wherein the second driving gear 252 engages the ballscrew gear 248.

FIG. 4 can also be described, using alternate nomenclature for some part numbers, as follows. An initial reduction set includes an initial reduction drive gear 246 (attached to the drive shaft 224) and an initial reduction driven gear 244. The initial reduction driven gear 244 and a secondary reduction drive gear 242 are attached coaxially and nonrotatably together to form the cluster gear set 216. A secondary reduction gear set includes the secondary reduction drive gear 242 (which is part of the cluster gear set 216) and a secondary reduction driven gear 248 (which is attached to the actuation member 218).

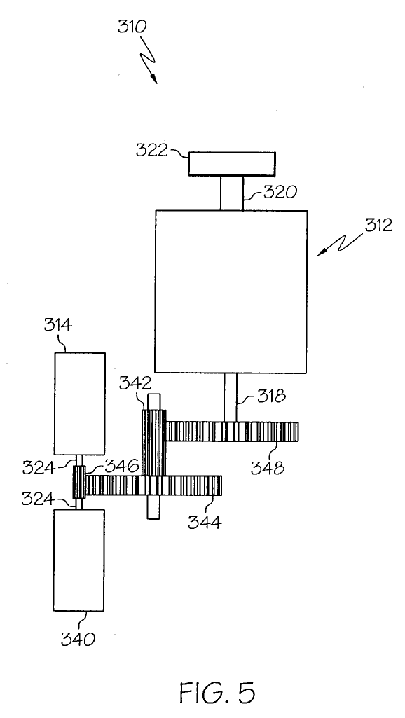

FIG. 5 shows an alternate configuration, wherein the electric mechanical brake assembly 310 also includes a second electric motor 340 which shares the first drive shaft 324 of the first electric motor 314, wherein the first motor gear 346 attached to the first drive shaft 324 engages the first driven gear 344. The first driving gear 342, the ballscrew gear 348, the actuation member 318, the ballscrew subassembly 312, the linearly-movable member 320, and the brake pad 322 are also shown. It is noted that two electric motors having separate drive shafts which are attached together are said to share a drive shaft.

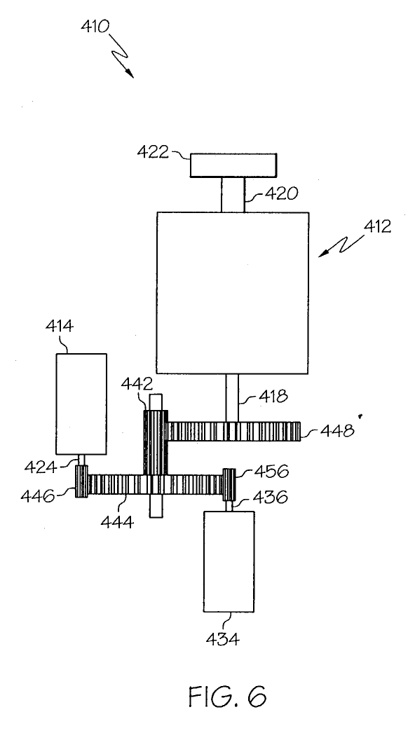

FIG. 6 shows a substitute configuration, wherein the electric mechanical brake assembly 410 also includes a second electric motor 434 having a second drive shaft 436 and having a second motor gear 456 attached to the second drive shaft 436 and engaging the first driven gear 444. The first driving gear 442, the ballscrew gear 448, the actuation member 418, the ballscrew subassembly 412, the linearly-movable member 420, the brake pad 422, the first electric motor 414, first drive shaft 424, and the first motor gear 446 are also shown.

A broader expression of the invention which includes the first expressions of both the previously-described first and second embodiments of the invention is for an electric mechanical brake assembly including an electric-mechanical-brake ballscrew subassembly, a first electric motor, and a first worm or cluster gear set. The electric-mechanical-brake ballscrew subassembly has a rotatable actuation member and has a linearly-movable member which is driven by the actuation member and which is attachable to a brake pad. The first electric motor has a first drive shaft. The first worm or cluster gear set at least in part operatively connects the first drive shaft to the actuation member.

In one example of the broader expression, the first worm or cluster gear set is a first worm gear set having a first worm gear attached to the actuation member and having a first worm attached to the first drive shaft and engaging the first worm gear.

In another example of the broader expression, the first worm or cluster gear set is a first cluster gear set having a first driving gear and having a first driven gear coaxially and nonrotatably attached to the first driving gear, wherein the first driven gear engages a first motor gear attached to the first drive shaft, and wherein the first driving gear engages a ballscrew gear attached to the actuation member.

In one configuration, the actuation member of the ballscrew assembly is a solid shaft.

Several benefits and advantages are derived from one or more of the embodiments of the invention. Having a worm or cluster gear set at least in part operatively connect the first drive shaft of the first electric motor to the actuation member of the electric-mechanical-brake ballscrew subassembly allows a greater gear reduction for similar size gear trains (or equal gear reduction in a smaller package size) than designs which use an idler gear and allows an equal gear reduction to designs which require a hollow (and more-costly-to-manufacture) shaft actuation member of the ballscrew subassembly to add required planetary reduction gears inside the hollow shaft actuation member. Typically, such embodiments of the invention have fewer parts and are more efficient by having fewer gear meshes.

The foregoing description of several expressions and several embodiments of the invention has been presented for purposes of illustration. It is not intended to be exhaustive or to limit the invention to the precise form disclosed, and obviously many modifications and variations are possible in light of the above teaching. It is intended that the scope of the invention be defined by the claims appended hereto.

1. An electric mechanical brake assembly comprising:
a) an electric-mechanical-brake ballscrew subassembly having a rotatable actuation member and having a linearly-movable member which is driven by the actuation member and which is attachable to a brake pad;
b) a first electric motor having a first drive shaft; and
c) a first worm or cluster gear set at least in part operatively connecting the first drive shaft to the actuation member.

2. The electric mechanical brake assembly of claim 1, wherein the first worm or cluster gear set is a first worm gear set having a first worm gear attached to the actuation member and having a first worm attached to the first drive shaft and engaging the first worm gear.

3. The electric mechanical brake assembly of claim 2, also including a second electric motor which shares the first drive shaft of the first electric motor.

4. The electric mechanical brake assembly of claim 2, also including a second electric motor having a second drive shaft, and further includes a second worm attached to the second drive shaft and engaging the first worm gear.

5. The electric mechanical brake assembly of claim 4, wherein the first and second worms are diametrically opposed about the first worm gear.

6. The electric mechanical brake assembly of claim 1, wherein the first worm or cluster gear set is a first cluster gear set having a first driving gear and having a first driven gear coaxially and nonrotatably attached to the first driving gear, wherein the first driven gear engages a first motor gear attached to the first drive shaft, and wherein the first driving gear engages a ball screw gear attached to the actuation member.

7. The electric mechanical brake assembly of claim 6, also including a second electric motor which shares the first drive shaft of the first electric motor.

8. The electric mechanical brake assembly of claim 6, also including a second electric motor having a second drive shaft and having a second motor gear attached to the second drive shaft and engaging the first driven gear.

9. The electric mechanical brake assembly of claim 6, also including a second electric motor having a second drive shaft, and further including a second cluster gear set having a second driving gear and having a second driven gear coaxially and nonrotatably attached to the second driving gear, wherein the second driven gear engages a second motor gear attached to the second drive shaft, and wherein the second driving gear engages the ballscrew gear.

10. The electric mechanical brake assembly of claim 1, wherein the actuation member of the ballscrew subassembly is a solid shaft.

11. An electric mechanical brake assembly comprising:
a) an electric-mechanical-brake ballscrew subassembly having a rotatable actuation member and having a linearly-movable member which is driven by the actuation member and which is attachable to a brake pad;
b) a first electric motor having a first drive shaft; and
c) a first worm gear set at least in part operatively connecting the first drive shaft to the actuation member.

12. The electric mechanical brake assembly of claim 11, wherein the first worm gear set has a first worm gear attached to the actuation member and has a first worm attached to the first drive shaft and engaging the first worm gear.

13. The electric mechanical brake assembly of claim 12, wherein the first worm gear has a first number of worm teeth, wherein the first worm has a worm thread, and wherein one turn of the first worm passes a number of worn teeth less than the first number.

14. The electric mechanical brake assembly of claim 13, wherein the actuation member of the ballscrew subassembly is a solid shaft.

15. An electric mechanical brake assembly comprising:
a) an electric-mechanical-brake ballscrew subassembly having a rotatable actuation member and having a linearly-movable member which is driven by the actuation member and which is attachable to a brake pad;
b) a first electric motor having a first drive shaft; and
c) a first cluster gear set at least in part operatively connecting the first drive shaft to the actuation member.

16. The electric mechanical brake assembly of claim 15, wherein the first cluster gear set has a first driving gear and has a first driven gear coaxially and is nonrotatably attached to the first driving gear, wherein the first driven gear engages a first motor gear attached to the first drive shaft, and wherein the first driving gear engages a ballscrew gear attached to the actuation member.

17. The electric mechanical brake assembly of claim 16, wherein the first driven gear has more gear teeth than the first motor gear, and wherein the ballscrew gear has more gear teeth than the first driving gear.

18. The electric mechanical brake assembly of claim 17, wherein the actuation member of the ballscrew subassembly is a solid shaft.
